(19) United States
(12) Patent Application Publication
(10) Pub. No.: US 2020/0199495 A1
(43) Pub. Date: Jun. 25, 2020

(54) PERFUME-CONTAINING DETERGENT COMPOSITION

(71) Applicant: RHODIA OPERATIONS, Paris (FR)

(72) Inventors: Florence LAMBERT, Paris (FR); Gilda LIZARRAGA, Chesterfield, NJ (US); Haizhou ZHANG, Shanghai (CN)

(21) Appl. No.: 16/632,615

(22) PCT Filed: Jul. 24, 2017
(86) PCT No.: PCT/CN2017/094075

§ 371 Date: Jan. 21, 2020

(51) Int. Cl. C11D 3/22; C11D 3/50; C11D 1/02; C11D 11/00

(52) U.S. Cl. CPC C11D 3/227; C11D 3/505; C11D 11/0017; C11D 1/02; C11D 3/222

(57) ABSTRACT

The present invention provides a method for enhancing perfume delivery of a perfume containing detergent composition, comprising the step of adding to said composition an amphoteric polysaccharide. The invention also provides a detergent composition comprising the amphoteric polysaccharide.

The present invention concerns a perfume containing detergent composition useful in various applications, particularly in laundry, cosmetic applications such as body wash, hand wash and shampoo, hard-surface cleaning and kitchenware wash as well, and a method for enhancing perfume delivery of a perfume-containing detergent composition, comprising the step of adding to said composition an amphoteric polysaccharide.

### PRIOR ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Detergent compositions generally have several benefits, the most common being to remove dirt and stains from substrates, such as fabrics, hairs, human bodies, glassware, kitchenware, floors and walls. Another benefit that detergent compositions can provide is to impart a pleasant smell to the compositions as well as the substrates treated by the compositions. Detergent compositions generally contain, in addition to the active ingredients, one or more perfumes. It would be an advantage to increase the delivery of perfume to a substrate so as to enhance the smell of the perfume on the treated substrate, and/or to enable the amount of perfume in the detergent compositions to be reduced for sake of cost saving.

US Patent Publication No. US2001/0034316 A1 discloses a fabric care composition which comprises a cationic fabric softening compound, a perfume and a polymer. The polymer is preferably a cationic polymer. It discloses that the composition can enhance the delivery of perfumes to fabrics.

PCT International Patent Publication No. WO1997048374 A2 discloses a liquid personal cleansing composition which provides enhanced perfume deposition on the skin. It discloses that the composition comprises a cationic material, such as a cationic guar.

The perfume delivery performance of known detergent compositions is still not satisfactory. Also, one drawback of laundry compositions containing cationic polymers is that such compositions cause yellowing (greying) of fabrics.

It remains a challenge to provide a system which can deliver perfumes or fragrances to a substrate, such as a fabric, which sustains the level of fragrance and which does not involve the concomitant loss of fragrance raw materials due to inadequate initial delivery. It remains a challenge to provide a laundry system which is universal to all fabric types and to all fabric laundry conditions and which does not alter the structure or appearance of fabrics.

### INVENTION

The present invention provides a method for enhancing perfume delivery of a perfume containing detergent composition, comprising the step of adding to said composition an amphoteric polysaccharide; wherein the amphoteric polysaccharide has a DS_{anionic} value greater than its DS_{cationic} value.

The present invention also concerns a detergent composition comprising at least:
a detergent,
a perfume, and
an amphoteric polysaccharide, notably for enhancing perfume delivery of the composition;

wherein the amphoteric polysaccharide has a DS_{anionic} value greater than its DS_{cationic} value, the amphoteric polysaccharide has a DS_{cationic} of 0.001 to 0.1. Preferably, the amphoteric polysaccharide has a DS_{anionic} of from 0.01 to 0.2.

In particular, the present invention provides a liquid detergent composition comprising:
from 1 to 20 wt % of a detergent,
from 0.001 to 0.5 wt % of a perfume,
from 0.1 to 1 wt % of an amphoteric polysaccharide, notably for enhancing perfume delivery of the composition; and
a liquid carrier;
wherein the amphoteric polysaccharide has a DS_{anionic} value greater than its DS_{cationic} value, the amphoteric polysaccharide has a DS_{cationic} of 0.001 to 0.1, weight percentage is based on the total weight of the detergent composition. Preferably, the amphoteric polysaccharide has a DS_{anionic} of from 0.01 to 0.2.

The present invention also concerns use of an amphoteric polysaccharide for enhancing perfume delivery of a detergent composition, wherein the amphoteric polysaccharide has a DS_{anionic} value greater than its DS_{cationic} value.

The method and the composition described herein are useful in various applications, particularly in laundry, body wash, hand wash, shampoo, hard-surface cleaning and kitchenware wash.

In context of the present invention, enhancing perfume delivery refers to providing enhanced perfume deposition to a substrate, providing increased on-substrate fragrance longevity, providing on-substrate fragrance strength, or a combination thereof. The substrate may be, for example, a fabric, a hair, a skin, kitchenware, glassware, a floor and a wall. “Perfume” may be any organic substance or composition which has a desired olfactory property and is essentially non-toxic. The perfume may be natural, semi-synthetic or synthetic in origin. The perfume may be an oil perfume or an encapsulated perfume.

The expression “detergent” is used to mean substance or material intended to assist cleaning or having cleaning properties. The term “detergency” indicates presence or degree of cleaning property. The degree of cleaning property can be tested on different stain containing substrate materials or stains or stain mixtures bound to solid, water-insoluble carrier, such as textile fibers or glass. Typical stain material includes oils, blood, milk, ink, egg, grass and sauces. Mixtures of stains for testing purposes are commercially available.

It has been found that the amphoteric polysaccharide of the present invention could enhance perfume delivery of the detergent composition. Addition of the amphoteric polysaccharide in the detergent composition could impart satisfactory perfume delivery performance even when the dosage of perfume present in the detergent composition is at very low level. It has also been found that the detergent composition of the present invention causes minimal greying of the fabrics.

Other characteristics, details and advantages of the invention will emerge even more fully upon reading the description which follows.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “between” should be understood as being inclusive of the limits.

It is specified that, in the continuation of the description, unless otherwise indicated, the values at the limits are included in the ranges of values which are given. It should be noted that in specifying any range of concentration, any particular upper concentration can be associated with any particular lower concentration.

As used herein, the term “hydrocarbon group” refers to a group mainly consisting of carbon atoms and hydrogen atoms, which group may be saturated or unsaturated, linear, branched or cyclic, aliphatic or aromatic. The term “hydrocarbyl” used in the description and the claims describes radicals which are based on hydrocarbons with the stated number of carbon atoms and which may be pure hydrocarbon radicals but may also have substituents. Hydrocarbon groups of the present invention may be alkyl groups, alkenyl groups, alkynyl groups, aryl groups, alkylaryl groups, aryalkyl groups, heterocyclic groups, and/or alkylheterocyclic groups.

Hydrocarbon groups of the present invention may be alkyl groups, alkenyl groups, alkynyl groups, aryl groups, alkylaryl groups, aryalkyl groups, heterocyclic groups, and/or alkylheterocyclic groups.

As used herein, the terminology “(Cₙ-Cₘ)” in reference to an organic group, wherein n and m are each integers, indicates that the group may contain from n carbon atoms to m carbon atoms per group.

As used herein, “alkyl” should be construed under the ordinary meaning. Alkyl groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

As used herein, “alkenyl” or “alkenyl group” refers to an aliphatic hydrocarbon radical which can be straight or branched, containing at least one carbon-carbon double bond.

Examples of alkenyl groups include, but are not limited to, ethenyl, propenyl, n-butenyl, i-butenyl, 3-methylbut-2-enyl, n-pentenyl, heptenyl, octenyl, decenyl, and the like. The term “alkynyl” refers to straight or branched chain hydrocarbon groups having at least one triple carbon to carbon bond, such as ethynyl.

The term “aryl group” includes unsaturated and aromatic cyclic hydrocarbons as well as unsaturated and aromatic heterocycles containing one or more rings. Aryl groups may also be fused or bridged with alicyclic or heterocyclic rings that are not aromatic so as to form a polycycle, such as tetralin. An “arylene” group is a divalent analog of an aryl group.

The term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated. Additionally, heterocyclic groups, such as pyrrolyl, pyridyl, isoquinolyl, quinolyl, purinyl, and furyl, may have aromatic character, in which case they may be referred to as “heteroaryl” or “heteroaromatic” groups.

It should be noted that a chemical moiety that forms part of a larger compound may be described herein using a name commonly accorded it when it exists as a single molecule or a name commonly accorded its radical. For example, the terms “pyridine” and “pyridyl” are accorded the same meaning when used to describe a moiety attached to other chemical moieties.

### DETAILS OF THE INVENTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

Amphoteric Polysaccharides

Suitable, non limitative, examples of polysaccharides include, for example, galactomannans, chitosan, pectin, alginate, hyaluronic acid, agar, xanthan, dextrin, starch, amylose, amylopectin, alternan, gellan, mutan, dextran, pullulan, fructan, gum arabic, carrageenan, glycogen, glycosaminoglycans, murein, xyloglucans and bacterial capsular polysaccharides.

In some embodiments, the polysaccharide include, for example, galactomannans such as guars, including guar derivatives, xanthans, polyfructoses such as levan, starches, including starch derivatives, such as amylopectin, xyloglucans such as tamarind gum and tamarind gum derivatives such as hydroxypropyl tamarind gum, and cellulose, including cellulose derivatives, such as methylcellulose, ethylcellulose, carboxymethylcellulose, hydroxyethylcellulose, cellulose acetate, cellulose acetate butyrate, and cellulose acetate propionate.

Galactomannans are polysaccharides consisting mainly of the monosaccharides mannose and galactose. The mannose-elements form a chain consisting of many hundreds of (1,4)-β-D-mannopyranosyl-residues, with 1,6 linked-D-galactopyranosyl-residues at varying distances, dependent on the plant of origin. Naturally occurring galactomannans are available from numerous sources, including guar gum, guar splits, locust bean gum and tara gum, flame tree gum and cassia gum. Additionally, galactomannans may also be obtained by classical synthetic routes or may be obtained by chemical modification of naturally occurring galactomannans.

Guar gum notably refers to the mucilage found in the seed of the leguminous plant Cyamopsis tetragonolobus. The water soluble fraction (85%) is called “guaran,” which consists of linear chains of (1,4)-β-D mannopyranosyl units-with -D-galactopyranosyl units attached by (1,6) linkages. The ratio of D-galactose to D-mannose in guaran is about 1:2. Guar gum typically has a weight average molecular weight of between 2,000,000 and 5,000,000 Daltons. Guars having a reduced molecular weight, such as, from about 2,000 to about 2,500,000 Daltons are also known.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78-82% galactomannan polysaccharide and minor amounts of some proteinaceous material, inorganic non-surfactant salts, water-insoluble gum, and cell membranes, as well as some residual seedcoat and embryo.

Locust bean gum or carob bean gum is the refined endosperm of the seed of the carob tree, Ceratonia siliqua. The ratio of galactose to mannose for this type of gum is about 1:4. Locust bean gum is commercially available.

Tara gum is derived from the refined seed gum of the tara tree. The ratio of galactose to mannose is about 1:3. Tara gum is also commercially available.

Xanthans of interest are xanthan gum and xanthan gel. Xanthan gum is a polysaccharide gum produced by Xathomonas campestris and contains D-glucose, D-mannose, D-glucuronic acid as the main hexose units, also contains pyruvate acid, and is partially acetylated.

Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

Tamarind (Tamahndus indica) is a leguminous evergreen tall tree produced in the tropics. Tamarind gum (tamarind powder or tamarind kernel powder), a xyloglucan polysaccharide, is obtained by extracting and purifying the seed powders, obtained by grinding the seeds of tamarind. The polysaccharide molecule of the tamarind gum consists of a main linear chain of poly-glucose bearing xylose and galactoxylose substituents.

In context of the present invention, the term “amphoteric polysaccharide” means a polysaccharide derivative which comprises at least one anionic substituent group and at least one cationic substituent group, and polysaccharide that may be made amphoteric, for example comprising a quaternizable amine group and/or an acid group.

The amphoteric polysaccharides may be chosen in particular from:
polysaccharides grafted with units A and B where A denotes a cationic unit derived from a monomeric or polymeric group containing at least one nitrogen atom belonging to a primary, secondary, tertiary or quaternary amine functional group, and B denotes an anionic unit derived from a monomeric or polymeric group containing one or more carboxylic acid, phosphoric acid, phosphonic acid, sulfate or sulfonic acid functional groups;
polysaccharides grafted with one or more units C, where C denotes a unit derived from a monomeric or polymeric group containing at least one zwitterionic group or carboxybetaines or sulfobetaines;
polysaccharides grafted with one or more units D, where D denotes a unit derived from a monomeric or polymeric group containing at least one anionic group derived from a monomeric or polymeric group containing one or more carboxylic acid, phosphoric acid, phosphonic acid, sulfate or sulfonic acid functional groups and at least one cationic group containing a primary, secondary, tertiary or quaternary amine functional group.

The amphoteric polysaccharide may additionally contain non-ionic functional groups which may be selected from:
hydroxy group, such as hydroxyethylated groups and hydroxypropylated groups
hydroxyalkyl group, such as hydroxymethyl hydroxyethyl, hydroxypropyl or hydroxybutyl.

Processes for making amphoteric polysaccharides are known. In particular, processes for making derivatives of guar gum splits are generally known. Typically, guar splits are reacted with one or more derivatizing agents under appropriate reaction conditions to produce a guar polysaccharide having the desired substituent groups. Suitable derivatizing reagents are commercially available and typically contain a reactive functional group, such as an epoxy group, a chlorohydrin group, or an ethylenically unsaturated group, and at least one other substituent group, such as a cationic, nonionic or anionic substituent group, or a precursor of such a substituent group per molecule, wherein substituent group may be linked to the reactive functional group of the derivatizing agent by bivalent linking group, such as an alkylene or oxyalkylene group. Suitable cationic substituent groups include primary, secondary, or tertiary amino groups or quaternary ammonium, sulfonium, or phosphinium groups. Suitable nonionic substituent groups include hydroxyalkyl groups, such as hydroxypropyl groups. Suitable anionic groups include carboxyalkyl groups, such as carboxymethyl groups. The cationic, nonionic and/or anionic substituent groups may be introduced to the polysaccharide chains via a series of reactions or by simultaneous reactions with the respective appropriate derivatizing agents.

For introduction of the substituent groups into the polysaccharide polymers, the polysaccharide polymers, for instance the guars, may be treated with a crosslinking agent, such for example, borax (sodium tetra borate) is commonly used as a processing aid in the reaction step of the water-splits process to partially crosslink the surface of the guar splits and thereby reduces the amount of water absorbed by the guar splits during processing. Other crosslinkers, such as, for example, glyoxal or titanate compounds, are known.

According to every one of the invention embodiments, the amphoteric polysaccharide is preferably a polysaccharide which is grafted with a cationic unit derived from a monomeric or polymeric group containing at least one nitrogen atom belonging to a primary, secondary, tertiary or quaternary amine functional group, and an anionic unit derived from a monomeric or polymeric group containing one or more carboxylic acid, phosphoric acid, phosphonic acid, sulfate or sulfonic acid functional groups, the amphoteric polysaccharide optionally containing non-ionic functional groups.

Advantageously, the amphoteric polysaccharide is an amphoteric galactomannan, such as an amphoteric guar. More advantageously, the amphoteric polysaccharide is chosen from:

carboxymethyl hydroxypropyltrimethylammonium chloride galactomannans, in particular carboxymethyl hydroxypropyltrimethylammonium chloride galactomannans guars;

carboxymethyl hydroxypropyl hydroxypropyltrimethylammonium chloride galactomannans, in particular carboxymethyl hydroxypropyl hydroxypropyltrimethylammonium chloride guars.

As used herein, the terminology “Degree of Substitution” (DS) in reference to a given type of derivatizing group and a given polysaccharide polymer means the number of the average number of such derivatizing groups attached to each monomeric unit of the polysaccharide polymer. In some embodiments, the amphoteric polysaccharide exhibits a total degree of substitution (“DST”) of from about 0.001 to about 3.0, wherein: DST is the sum of the DS for cationic substituent groups (“DS_{cationic}” or “cationic Degree of Substitution”), the DS for nonionic substituent groups (“DS_{nonionic}” or “nonionic Degree of Substitution) and the DS for anionic substituent groups (“DS_{anionic}” or “anionic Degree of Substitution”). DS_{cationic}, DS_{nonionic}, and DS_{anionic} may be measured for instance by 1H-NMR.

In the amphoteric polysaccharides of the present invention:
DS_{cationic} is preferably from about 0.001 to about 3, more typically from about 0.001 to about 1.0, and even more typically from about 0.001 to about 0.5, in particular from about 0.001 to about 0.1. Preferably DS_{cationic} is equal to 0.01, 0.02, 0.03, 0.04, 0.05, 0.06, 0.07, 0.08, 0.09 and 0.1 or any range comprised between these values.
DS_{anionic} may be from about 0.01 to about 3.0, more typically from about 0.001 to about 1.0 and even more typically from about 0.1 to about 0.6, in particular from about 0.01 to about 0.2. Preferably DS_{anionic} is equal to 0.1, 0.12, 0.14, 0.16, 0.18 and 0.2 or any range comprised between these values.
DS_{nonionic} may be from 0 to about 3.0, more typically from about 0.001 to about 2.5, and even more typically from about 0.001 to about 1.0.

The amphoteric polysaccharide of the present invention has a DS_{anionic} value greater than its DS_{cationic} value, in other words, the amphoteric polysaccharide has a negative net charge. Preferably, the amphoteric polysaccharide has a DS_{anionic} value greater than its DS_{cationic} value and the DS_{cationic} is in the range of from 0.01 to 1.0, more preferably from 0.01 to 0.5, even more preferably from 0.01 to 0.1.

Preferably, the ratio between DS_{anionic} and DS_{cationic} of the amphoteric polysaccharide (absolute value) is from 1.2:1 to 10:1, more preferably from 1.2:1 to 5:1.

As used herein, the term “Molar Substitution” or “MS” refers to the number of moles of derivatizing groups per moles of monosaccharide units of the polysaccharide. The molar substitution can be determined by the Zeisel-GC method. The Molar Substitution utilized by the present invention is typically in the range of from about 0.001 to about 3.

The amphoteric polysaccharide, such as the amphoteric guar, preferably has an average molecular weight (Mw) of between 100,000 Daltons and 3,500,000 Daltons, more preferably between 500,000 Daltons and 2,500,000 Daltons, even more preferably between 1,000,000 Daltons and 2,500,000 Daltons.

In some embodiments, the amphoteric polysaccharide, such as the amphoteric galactomannan, has a DS_{anionic} value greater than its DS_{cationic} value, and has an average molecular weight of from 1,000,000 Daltons to 2,500,000 Daltons.

In some embodiments, the amphoteric polysaccharide, such as the amphoteric galactomannan, has a DS_{anionic} value greater than its DS_{cationic} value, and has a DS_{cationic} of 0.001 to 0.1.

In some embodiments, the amphoteric polysaccharide, such as the amphoteric galactomannan, has a DS_{anionic} value greater than its DS_{cationic} value, has a DS_{cationic} of 0.001 to 0.1 and a DS_{anionic} of from 0.01 to 0.2.

In some embodiments, the amphoteric polysaccharide, such as the amphoteric galactomannan, has a DS_{anionic} value greater than its DS_{cationic} value, has a DS_{cationic} of 0.001 to 0.1, and has an average molecular weight of from 1,000,000 Daltons to 2,500,000 Daltons.

In some embodiments, the amphoteric polysaccharide, such as the amphoteric galactomannan, has a DS_{anionic} value greater than its DS_{cationic} value, has a DS_{cationic} of 0.001 to 0.1 and a DS_{anionic} of from 0.01 to 0.2, and has an average molecular weight of from 1,000,000 Daltons to 2,500,000 Daltons.

The amphoteric polysaccharide may be present in an amount of from 0.01 to 5 wt %, based on total weight of the detergent composition, preferably, 0.1 to 1 wt %, more preferably from 0.3 to 0.8 wt %.

Detergent

The detergent composition may comprise one or more surfactants as the detergent active ingredient, which may be anionic and/or cationic and/or non-ionic and/or semipolar and/or zwitterionic, or a mixture thereof.

In some embodiments, the detergent composition comprises a mixture of one or more nonionic surfactants and one or more anionic surfactants. The surfactant(s) is typically present at a level of from about 0.1% to 60% by weight, such as about 1% to about 40%, or about 1% to about 20%, or about 3% to about 10%. The surfactant(s) is chosen based on the desired cleaning application, and may include any conventional surfactant(s) known in the art.

Notably, the detergent active ingredient is an anionic surfactant. When included therein, the detergent composition may usually contain from about 1% to about 40% by weight of an anionic surfactant, such as from about 5% to about 30%, including from about 1% to about 20%, or from about 15% to about 20%, or from about 20% to about 25% of an anionic surfactant.

Non-limiting examples of anionic surfactants include sulfates and sulfonates, in particular, linear alkylbenzenesulfonat.es (LAS), isomers of LAS, branched alkylbenzenesulfonat.es (BABS), phenylalkanesulfonat.es, alpha-olefinsulfonates (AOS), olefin sulfonates, alkene sulfonates, alkane-2,3-diylbis(sulfates), hydroxyalkanesulfonat.es and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.

The anionic surfactant may include alkyl ether sulphates, soaps, fatty acid ester sulphonates, alkylamide sulfates, alkyl benzene sulphonates, sulphosuccinate esters, primary alkyl sulphates, olefin sulphonates, paraffin sulphonates and organic phosphate. Preferred anionic surfactants are the alkali and alkaline earth metal salts of fatty acid carboxylates, fatty alcohol sulphates, preferably primary alkyl sulfates, more preferably they are ethoxylated, for example alkyl ether sulphates; alkylbenzene sulphonates, alkyl ester fatty acid sulphonates, especially methyl ester fatty acid sulphonates and mixtures thereof.

Particular anionic surfactants which can be mentioned are:
alkyl ester sulfonates of formula R′—CH(SO₃M)-COOR″, in which R′ represents a C₈-C₂₀ and preferably C₁₀-C₁₆ alkyl radical, R″ represents a C₁-C₆ and preferably C₁-C₃ alkyl radical and M represents an alkali metal (sodium, potassium or lithium) cation, a substituted or unsubstituted ammonium (methyl-, dimethyl-, trimethyl- or tetramethylammonium, dimethylpiperidinium, etc.) or an alkanolamine derivative (monoethanolamine, diethanolamine, triethanolamine, etc.). Mention may be made most particularly of methyl ester sulfonates in which the radical R′ is C₁₄-C₁₆;
alkyl sulfates of formula R′OSO₃M, in which R′ represents a C₅-C₂₄ and preferably C₁₀-C₁₈ alkyl or hydroxyalkyl radical, M representing a hydrogen atom or a cation of the same definition as above, and also the ethoxylenated (EO) and/or propoxylenated (PO) derivatives thereof, containing on average from 0.5 to 30 and preferably from 0.5 to 10 EO and/or PO units;
alkylamide sulfates of formula R′CONHR″OSO₃M in which R′ represents a C₂-C₂₂ and preferably C₆-C₂₀ alkyl radical, R″ represents a C₂-C₃ alkyl radical, M representing a hydrogen atom or a cation of the same definition as above, and also the ethoxylenated (EO) and/or propoxylenated (PO) derivatives thereof, containing on average from 0.5 to 60 EO and/or PO units;
saturated or unsaturated C₈-C₂₄ and preferably C₁₄-C₂₀ fatty acid salts, C₉-C₂₀ alkylbenzenesulfonates, primary or secondary C₈-C₂₂ alkylsulfonates, alkylglyceryl sulfonates, sulfonated polycarboxylic acids, paraffin sulfonates, N-acyl N-alkyltaurates, alkyl phosphates, isethionates, alkyl succinamates, alkyl sulfosuccinates, sulfosuccinate monoesters or diesters, N-acyl sarcosinates, alkylglycoside sulfates, polyethoxycarboxylates; the cation being an alkali metal (sodium, potassium or lithium), a substituted or unsubstituted ammonium residue (methyl-, dimethyl-, trimethyl- or tetramethylammonium, dimethylpiperidinium, etc.) or an alkanolamine derivative (monoethanolamine, diethanolamine, triethanolamine, etc.).

When included therein, the detergent composition may usually contain from about from about 0.1% to about 20% by weigh of a cationic surfactant, for example from about 0.1% to about 10%, in particular from about 0.1% to about 5%, from about 0.1% to about 2%.

A variety of quaternary ammonium cationic surfactant may be utilized as the cationic surfactant for the present invention; however acyclic quaternary surfactants are preferred. For example, useful quaternary synthetic surfactants that are acyclic include linear alkyl, branched alkyl, hydroxyalkyl, oleylalkyl, acyloxyalkyl, diamidoamine, or diester quaternary ammonium compounds. The preferred quaternary surfactants for use in the present invention are waxy solids or are highly viscous at ambient temperature such that the material can be melted and applied hot to the substrate, and these may include traditional tetraalkyl materials or ester quaternaries, or combinations of the two types. It may be preferred that the quaternary ammonium cationic surfactant is a fabric softening agent. It may also be preferred that the quaternary ammonium cationic surfactant is an anti-static agent.

Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein, the detergent composition may usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or /V-acyl/V-alkyl derivatives of glucosamine (glucamides, GA, or fatty acid glucamides, FAGA), as well as products available under the trade names SPAN and TWEEN, and combinations thereof.

When included therein, the detergent composition may usually contain from about 0% to about 20% by weight of a semipolar surfactant. Non-limiting examples of semipolar surfactants include amine oxides (AO) such as alkyldimethylamineoxide, /V-(coco alkyl)-/V,/V-dimethylamine oxide and N-(tallow-alkyl)-/V,/V-bis(2-hydroxyethyl)amine oxide, and combinations thereof.

When included therein, the detergent composition may usually contain from about 0% to about 20% by weight of a zwitterionic surfactant. Non-limiting examples of zwitterionic surfactants include betaines such as alkyldimethylbetaines, sulfobetaines, and combinations thereof.

Perfume

As used herein, the term “perfume” means any organic substance or composition which has a desired olfactory property and is essentially non-toxic. Such substances or compositions include all fragrance material and perfumes that are commonly used in perfumery or in household compositions (laundry detergents, fabric conditioning compositions, soaps, all-purpose cleaners, bathroom cleaners, floor cleaners) or personal care compositions. The compounds involved may be natural, semi-synthetic or synthetic in origin.

Preferred perfumes may be assigned to the classes of substance comprising the hydrocarbons, aldehydes or esters. The perfumes also include natural extracts and/or essences, which may comprise complex mixtures of constituents, i.e. fruits such as almond, apple, cherry, grape, pear, pineapple, orange, lemon, strawberry, raspberry and the like; musk, flower scents such as lavender, jasmine, lily, magnolia, rose, iris, carnation and the like; herbal scents such as rosemary, thyme, sage and the like; woodland scents such as pine, spruce, cedar and the like.

Non limitative examples of synthetic and semi-synthetic perfumes are: 7-acetyl-1,2,3,4,5,6,7,8-octahydro-1,1,6,7-tetramethylnaphthalene, α-ionone, β-ionone, γ-ionone, α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl b-naphthyl ketone, 6-acetyl-1,1,2,3,3,5-hexamethylindane, 5-acetyl-3-isopropyl-1,1,2-,6-tetramethylindane, 1-dodecanal, 4-(4-hydroxy-4-methylpentyl)-3-cyclohex-ene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl)propionaldehyde, ethylvanillin, heliotropin, hexylcinnamaldehyde, amylcinnamaldehyde, 2-methyl-2-(isopropylphenyl)propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-g-benzopyran, β-naphthol methyl ether, ambroxane, dodecahydro-3a,6,6,9a-tetramethylnaphtho[2,1 b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Particular preference is given to the following:

hexylcinnamaldehyde, 2-methyl-3-(tert-butylphenyl)propionaldehyde, 7-acetyl-1,2,3,4,5,6,7,8-octahydro-1,1,6,7-tetramethylnaphthalene, benzyl salicylate, 7-acetyl-1,1,3,4,4,6-hexamethyltetralin, para-tert-butylcyclohexyl acetate, methyl dihydrojasmonate, (β-naphthol methyl ether, methyl g-naphthyl ketone, 2-methyl-2-(para-isopropylphenyl)propionaldehyde, 1,3,4,6,7,8-hexahydro-4,6,6,7,8,8-hexamethylcyclopenta-g-2-benzopyran, dodecahydro-3a,6,6,9a-tetramethylnaphtho[2,1 b]furan, anisaldehyde, coumarin, cedrol, vanillin, cyclopentadecanolide, tricyclodecenyl acetate and tricyclodecenyl propionates.

Other perfumes are essential oils, resinoids and resins from a large number of sources, such as, Peru balsam, olibanum resinoid, styrax, labdanum resin, nutmeg, cassia oil, benzoin resin, coriander, clary sage, eucalyptus, geranium, lavender, mace extract, neroli, nutmeg, spearmint, sweet violet leaf, valerian and lavandin.

Some or all of the perfumes may be encapsulated, typical perfume components which it is advantageous to encapsulate, include those with a relatively low boiling point. It is also advantageous to encapsulate perfume components which have a low C log P (i.e. those which will be partitioned into water), preferably with a C log P of less than 3.0. As used herein, the term “C log P” means the calculated logarithm to base 10 of the octanol/water partition coefficient (P).

Further suitable perfumes include: phenylethyl alcohol, terpineol, linalool, linalyl acetate, geraniol, nerol, 2-(1,1-dimethylethyl)cyclo-hexanol acetate, benzyl acetate, and eugenol.

Perfumes frequently include solvents or diluents, for example: ethanol, isopropanol, diethylene glycol monoethyl ether, dipropylene glycol, diethyl phthalate and triethyl citrate.

The detergent composition of the present invention may comprise from 0.01 to 10 wt % of the perfume based on total weight of the detergent composition. Preferably, the detergent composition comprises from 0.1 to 5 wt % of the perfume based on total weight of the composition. More preferably, the detergent composition comprises from 0.1 to 2 wt % of the perfume based on total weight of the detergent composition.

Enzyme

According to the present invention, the detergent composition may further contain an enzyme. Enzymes can perform two main roles in the detergent composition: effect stain removal and provide color and fabric care.

The enzyme is preferably selected from the group constituted by: hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. Preferably, the enzymes are proteases, amylases and lipases.

The most commonly used enzymes are proteases (break down protein), amylases (break down starch—a type of carbohydrate) and lipases (break down fats).

Preferred enzymes could include a protease. Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

Suitable proteases include metalloproteases and serine proteases, including neutral or alkaline microbial serine proteases, such as subtilisins (EC 3.4.21.62). In one aspect, such suitable protease may be of microbial origin. The suitable proteases include chemically or genetically modified mutants of the aforementioned suitable proteases.

In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii.

(b) trypsin-type or chymotrypsin-type proteases, such as trypsin (e.g., of porcine or bovine origin), including Fusarium protease and chymotrypsin proteases derived from Cellumonas.

(c) metalloproteases, including those derived from Bacillus amyloliquefaciens.

(d) subtilisin proteases derived from the Bacillus sp TY-145, NCIMB 40339.

Preferred proteases include those derived from Bacillus gibsonii, Bacillus amyloliquefaciens, Bacillus sp. TY-145 or Bacillus Lentus.

Examples of useful proteases are the variants described in: WO92/19729, WO96/034946, WO98/20115, WO98/20116, WO99/011768, WO01/44452, WO03/006602, WO04/03186, WO04/041979, and WO07/006305.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Blaze®, Everlase® and Esperase® by Novozymes A/S, those sold under the tradename Maxatase®, Maxacal®, Maxapem®, Properase®, Purafect®, Purafect Prime®, Purafect Ox®, FN3®, FN4®, Excellase®, Ultimase®, Purafect OXP® and the Preferenz P® series by DuPont International Biosciences, those sold under the tradename Opticlean® and Optimase® by Solvay Enzymes, those available from BASF, namely BLAP, BLAP R, BLAP X and BLAP F49-all from BASF; and KAP (Bacillus alkalophilus subtilisin) from Kao.

Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375, DSM 12368, DSMZ no. 12649, KSM AP1378, KSM K36 or KSM K38.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, EVEREST®, FUNGAMYL® and BAN® (Novozymes A/S), KEMZYM® AT 9000 from Biozym Biotech Trading GmbH, RAPIDASE®, PURASTAR®, ENZYSIZE®, OPTISIZE HT PLUS®, POWERASE® and PURASTAR OXAM®, PREFERENZ® S series, including PREFERENZ S1000 and PREFERENZ S110 (DuPont) and KAM® (Kaoln one aspect, suitable amylases include NATALASE®, EVEREST®, PREFERENZ S1000®, STAINZYME® and STAINZYME PLUS® and mixtures thereof.

In some embodiments, the enzymes may be selected from the group consisting of: lipases, including “first cycle lipases”. In some embodiments, the lipase is a first-wash lipase, preferably a variant of the wild-type lipase from Thermomyces lanuginosus.

Preferred lipases would include those sold under the tradenames Lipex®, Lipoclean®, Calipso® and Lipolex®.

Other preferred enzymes include fungal and microbial-derived endoglucanases exhibiting endo-beta-1,4-glucanase activity (E.C. 3.2.1.4). Suitable endoglucanases are sold under the tradenames Celluclean®, Carezyme®, Celluzyme®, Carezyme Premium® and Whitezyme® (Novozymes A/S).

Other preferred enzymes include pectate lyases sold under the tradenames Pectawash®, Pectaway®, Xpect® and mannanases sold under the tradenames Mannaway® (all from Novozymes A/S), and Preferenz F® and Purabrite® (DuPont

Suitable perhydrolases are capable of catalyzing a perhydrolysis reaction that results in the production of a peracid from a carboxylic acid ester (acyl) substrate in the presence of a source of peroxygen (e.g., hydrogen peroxide). While many enzymes perform this reaction at low levels, perhydrolases exhibit a high perhydrolysis:hydrolysis ratio, often greater than 1. Suitable perhydrolases may be of plant, bacterial or fungal origin.

Chemically modified or protein engineered mutants are included. Examples of useful perhydrolases include naturally occurring Mycobacterium perhydrolase enzymes, or variants thereof. An exemplary enzyme is derived from Mycobacterium smegmatis.

Suitable oxidases and peroxidases (or oxidoreductases) include various sugar oxidases, laccases, peroxidases and haloperoxidases. Suitable peroxidases include those comprised by the enzyme classification EC 1.11.1.7, as set out by the Nomenclature Committee of the International Union of Biochemistry and Molecular Biology (IUBMB), or any fragment derived therefrom, exhibiting peroxidase activity. Suitable peroxidases include those of plant, bacterial or fungal origin. Chemically modified or protein engineered mutants are included. Examples of useful peroxidases include peroxidases from Coprinopsis, e.g., from C. cinerea and variants thereof.

Oxidases according to the invention include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata or Coriolus, e.g., C. irsutus).

Suitable examples from bacteria include a laccase derivable from a strain of Bacillus. A laccase derived from Coprinopsis or Myceliophthora is preferred; in particular a laccase derived from Coprinopsis cinerea; or from Myceliophthora thermophila.

Examples of other oxidases include, but are not limited to, amino acid oxidase, glucose oxidase, lactate oxidase, galactose oxidase, polyol oxidase and aldose oxidase. Oxidases and their corresponding substrates may be used as hydrogen peroxide generating enzyme systems, and thus a source of hydrogen peroxide. Several enzymes, such as peroxidases, haloperoxidases and perhydrolases, require a source of hydrogen peroxide.

The enzyme may be in liquid form which can be dispersed in the detergent composition. The enzyme may also be added in a solid form or as a capsule. Solid forms would include granules that can be made by fluid bed coating such as layered granules. Preferably said microcapsules and granules are coated with a polymer that provides triggered release via an ionic strength trigger such that said granule and/or capsule is stable in product but upon dilution in water will release its enzyme payload. Examples of such polymeric coatings include cellulose derivatives, such as hydroxypropyl methyl cellulose derivatives, particularly hydroxyl propyl methyl cellulose phthalate and cellulose acetate phthalate. A further preferred polymeric coating is polyvinyl alcohol. It is further preferred that any capsules and/or granules are density-matched to the surrounding liquid matrix to promote stability and prevent settling out of a visible phase. In a further aspect the enzymes can be added as capsules and/or microcapsules derived from interfacial polymerization reaction of a polyamine, preferably a branched polyamine. Said microcapsules can be made by recation of polyamines, such as those sold under the Lupasol tradename by BASF with an acid chloride.

For the granules preferred particle sizes are from 50 to 1000 m, preferable from 50 to 500 m, most preferably from 100-250 m. For the capsules preferred particle sizes are from 1 to 1000 m, preferably 5 to 200 m, most preferably from 10 to 100 m.

The enzyme may be present in an amount of from 0.01 to 5 wt %, based on the total weight of the detergent composition, preferably, 0.1 to 2 wt %, more preferably from 0.5 to 1.5 wt %.

Builders and Co-Builders

The detergent composition may further contain about 0-65% by weight, such as about 5% to about 50% of a detergent builder or co-builder, or a mixture thereof. In a washing detergent, the level of builder is typically 40-65%, particularly 50-65%. The builder and/or co-builder may particularly be a chelating agent that forms water-soluble complexes with Ca and Mg. Any builder and/or co-builder known in the art for use in laundry cleaning detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain 0-50% by weight, such as about 5% to about 30%, of a detergent co-builder. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-/V,/V′-disuccinic acid (EDDS), methylglycinediacetic acid (MGDA), glutamic acid-/V,/V-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-/V-monoacetic acid (ASMA), aspartic acid-Λ/,/V-di acetic acid (ASDA), aspartic acid-/V-monopropionic acid (ASMP), iminodisuccinic acid (IDA), /V-(2-sulfomethyl)-aspartic acid (SMAS), /V-(2-sulfoethyl)-aspartic acid (SEAS), /V-(2-sulfomethyl)-glutamic acid (SMGL), /V-(2-sulfoethyl)-glutamic acid (SEGL), /V-methyliminodiacetic acid (Ml DA), a-alanine-/V,/V-diacetic acid (a-ALDA), serine-/V,/V-diacetic acid (SEDA), isoserine-/V,/V-diacetic acid (ISDA), phenylalanine-/V,/V-diacetic acid (PHDA), anthranilic acid-/V,/V-diacetic acid (ANDA), sulfanilic acid-/V,/V-diacetic acid (SLDA), taurine-/V,/V-diacetic acid (TUDA) and sulfomethyl-/V,/V-diacetic acid (SMDA), /V-(2-hydroxyethyl)ethylenediamine-/V,/V′,/V″-triacetic acid (HEDTA), diethanolglycine (DEG), diethylenetriamine penta(methylenephosphonic acid) (DTPMP), aminotris(methylenephosphonic acid) (ATMP), and combinations and salts thereof.

Further exemplary builders and/or co-builders are described in, e.g., WO 09/102854, U.S. Pat. No. 5,977,053.

Bleaching Systems

The detergent composition may contain 0-30% by weight, such as about 1% to about 20%, of a bleaching system. Any bleaching system known in the art for use in laundry cleaning detergents may be utilized. Suitable bleaching system components include bleaching catalysts, photobleaches, bleach activators, sources of hydrogen peroxide such as sodium percarbonate, sodium perborates and hydrogen peroxide-urea (1:1), preformed peracids and mixtures thereof. Suitable preformed peracids include, but are not limited to, peroxycarboxylic acids and salts, diperoxydicarboxylic acids, perimidic acids and salts, peroxymonosulfuric acids and salts, for example, Oxone®, and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with hydrogen peroxide to form a peracid via perhydrolysis. The peracid thus formed constitutes the activated bleach.

Preferably the bleach component comprises a source of peracid in addition to bleach catalyst, particularly organic bleach catalyst. The source of peracid may be selected from (a) pre-formed peracid; (b) percarbonate, perborate or persulfate salt (hydrogen peroxide source) preferably in combination with a bleach activator; and (c) perhydrolase enzyme and an ester for forming peracid in situ in the presence of water in a textile or hard surface treatment step.

Polymers

The detergent composition may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), polyvinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-/V-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO2006/130575. Salts of the above-mentioned polymers are also contemplated.

Fabric Hueing Agents

The detergent composition may also include fabric hueing agents such as dyes or pigments, which when formulated in detergent compositions can deposit onto a fabric when said fabric is contacted with a wash liquor comprising said detergent composition and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243

Adjunct Materials

Any detergent components known in the art, notably for use in laundry cleaning detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry cleaning detergents may be utilized. The choice of such ingredients is well within the skill of the artisan.

The detergent composition can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

The detergent composition may also include one or more dye transfer inhibiting agents. Suitable polymeric dye transfer inhibiting agents include, but are not limited to, polyvinylpyrrolidone polymers, polyamine /V-oxide polymers, copolymers of N-vinylpyrrolidone and /V-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

The detergent composition may preferably contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives.

The detergent composition may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO2009/087523. Furthermore random graft co-polymers are suitable soil release polymers. Suitable graft co-polymers are described in more detail in WO2007/138054, WO2006/108856 and WO2006/113314.

The detergent composition may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

The detergent composition may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

Application

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid. Preferably, the detergent composition is in liquid form, such as a gel, a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

The detergent composition, when in liquid form, may be aqueous, typically containing at least 20% by weight and up to 95% water as the liquid carrier, such as up to about 70% water, up to about 65% water, up to about 55% water, up to about 45% water, up to about 35% water. Other types of liquid carriers, including without limitation, alkanols, amines, diols, ethers and polyols may be included in the liquid detergent composition. The liquid detergent composition may contain from 0-30% organic solvent. The liquid detergent composition may also be non-aqueous.

In one aspect of the present invention, there is provided a liquid detergent composition comprising:
from 1 to 20 wt % of a detergent,
from 0.001 to 0.5 wt % of a perfume, and
from 0.1 to 1 wt % of an amphoteric polysaccharide, notably for enhancing perfume delivery of the composition, and
a liquid carrier;

wherein the amphoteric polysaccharide has a DS_{anionic} value greater than its DS_{cationic} value, the amphoteric polysaccharide has a DS_{cationic} of 0.001 to 0.1; weight percentage is based on total weight of the detergent composition. Preferably, the amphoteric polysaccharide has a DS_{anionic} of from 0.01 to 0.2.

It has been found that by addition of the amphoteric polysaccharide, the perfume dosage required for achieving satisfactory perfume delivery could be reduced, for example, reduced to no more than 0.5 wt % based on total weight of the detergent composition.

For preparing the liquid detergent composition, the amphoteric polysaccharide component can be added to the liquid carrier or a detergent base simultaneously with other components, such as the perfume. Components of the detergent compositions may also be added sequentially, while the sequence of addition shall not be particularly restricted. According to every one of the invention embodiments, the amphoteric polysaccharide is preferably dispersed or dissolved in the liquid detergent composition.

The detergent composition may be a laundry soap bar. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH4⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The invention is not limited to preparing the laundry soap bars by any single method. Besides the mixing step and the plodding step, the process may further comprise the steps of milling, extruding, cutting, stamping, cooling and/or wrapping.

The detergent composition of the present invention may be used for cosmetic formulations, which may be in the form of a mousse, a gel, a spray or a lacquer and may be used in rinse-out or leave-in application.

The detergent composition may be used as hair products, especially rinse-out or leave-in products, and in particular for washing, caring for and/or conditioning the hair, holding the hairstyle, and shaping, dyeing, bleaching, permanently reshaping or relaxing the hair.

The detergent composition of the invention may also be used as care or hygiene products such as protective, treating or care creams for the face, the hands or the body, protective or care body milks, gels or mousses for caring for or cleansing the skin, or alternatively as products for making up or for removing makeup from the skin, the lips, the nails and the eyelashes.

The disclosure will now be illustrated with working examples, which is intended to illustrate the working of disclosure and not intended to take restrictively to imply any limitations on the scope of the present disclosure. Other examples are also possible which are within the scope of the present disclosure.

Materials:
Fragrance free liquid detergent from Earthwise
Different guars
Perfumes
250 ppm hard water
Fabrics: Polyester/Cotton (PECO) 50/50, cut into 15 cm×15 cm size.

### Example 1

Pretreatment of Fabrics:
Washing machine model: Samsung Top Load (WA90F5S9)
Detergent: Earthwise fragrance free detergent
Dosage of detergent: 80 g/80 pieces of PECO towels
Wash temperature: room temperature

All fabrics were washed and tumbled dry in dryer (Elba Sensordry Dual Heat EB422), to ensure fabrics are odor free before further use.

The liquid laundry detergent base was prepared in advance using the formulation and procedure as follows:
1. The perfume (0.5 wt % of the detergent base) was added into the fragrance free liquid detergent base and left to age overnight. The guar was dispersed in water first, by adding guar powder into distilled water while stirring was continuously provided. Then, calculated amounts of perfumed detergent base and the guar solution were added into pots for washing. For example, when 1 g detergent base was added into the washing pot with 500 ml water, and the guar powder was 0.5 wt % of the detergent base in this case, which was equal to 0.001 wt % in the final washing condition. Washing was conducted according to standard procedures.

| | |
|---|---|
| Instrument | Launderometer (SDL Atlas Rotawash M228) |
| Water dosage per pot | 500 g |
| Detergent | Earthwise fragrance free liquid detergent |
| Detergent dosage | 2 g/L |
| fabric per washing pot | 1 (15 cm by 15 cm) |
| Fabric type | PECO |
| Guar | 0.5 wt % of detergent base |
| Perfume | 0.5 wt % of detergent base |

2. After washing, removed and squeezed water from the fabrics.
3. For rinsing, placed the fabrics back into a clean pot with 500 ml water. Placed the pots back into the launderometer and rotated for 3 minutes for rinsing.
4. After rinsing, removed and squeezed water from the fabrics.
5. Dried the fabrics at room temperature overnight on aluminum foils.

Fragrance Strength Evaluation:

Fragrance assessment was carried out in a clean, odor-free environment. The fragrance intensity of the treated fabrics was evaluated by a group of panelist. The panelists smelt the treated fabrics and compared the fragrance intensity between the experimental group and the control group (no guar was added), and evaluated whether the fragrance intensity of the experimental group was stronger than that of the control group. The results were presented as: number of panelists (the experimental group has a stronger fragrance intensity):number of panelists (the experimental group does not have a stronger fragrance intensity).

The formulations and the results were shown in Table 1 below:

TABLE 1

| | Control | S1 | S2 | S3 | CS1 | CS2 |
|---|---|---|---|---|---|---|
| Components | wt % | wt % | wt % | wt % | wt % | wt % |
| Detergent base, | 0.2 | 0.2 | 0.2 | 0.2 | 0.2 | 0.2 |
| Fragrance Free | | | | | | |
| Perfume 1 | 0.001 | 0.001 | 0.001 | 0.001 | 0.001 | 0.001 |
| Amphoteric PS1 | — | 0.001 | — | — | — | — |
| Amphoteric PS2 | — | — | 0.001 | — | — | — |
| Amphoteric PS3 | — | — | — | 0.001 | — | — |
| Amphoteric PS4 | — | — | — | — | 0.001 | — |
| Anionic PS | — | — | — | — | — | 0.001 |
| Water | To 100 | To 100 | To 100 | To 100 | To 100 | To 100 |
| Panalists' | — | 8:0 | 6:2 | 7:1 | 4:4 | 4:4 |
| evaluation (8 | | | | | | |
| panalists in total) | | | | | | |

(S means Sample and CS means Comparative Sample)

Amphoteric PS (polysaccharide) 1 is a carboxymethyl hydroxypropyl trimethylammonium chloride guar having an average molecular weight of about 2,000,000 Daltons and having a cationic Degree of Substitution of 0.09 and an anionic Degree of Substitution of 0.17, available from Solvay.

Amphoteric PS2 is a carboxymethyl hydroxypropyl trimethylammonium chloride guar having an average molecular weight of about 2,000,000 Daltons and having a cationic Degree of Substitution of 0.045 and an anionic Degree of Substitution of 0.17, available from Solvay.

Amphoteric PS3 is a carboxymethyl hydroxypropyl trimethylammonium chloride guar having an average molecular weight of about 2,000,000 Daltons and having a cationic Degree of Substitution of 0.09 and an anionic Degree of Substitution of 0.17, available from Solvay.

Amphoteric PS4 is a carboxymethyl hydroxypropyl trimethylammonium chloride guar having an average molecular weight of about 600,000 Daltons and having a cationic Degree of Substitution of 0.23 and an anionic Degree of Substitution of 0.17, available from Solvay.

Anionic PS is a carboxymethyl hydroxypropyl guar having an average molecular weight of about 2,000,000 Daltons and having an anionic Degree of Substitution of about 0.17, available from Solvay.

Perfume 1 is oil perfume.

Results showed that amphoteric guars according to the present invention led to markedly stronger fragrance on the treated fabrics, compared to the control (without any guar). In contrast, the amphoteric guar having an anionic Degree of Substitution value that is lower than its cationic Degree of Substitution value led to almost the same fragrance intensity compared to the control. The anionic guar also led to almost the same fragrance intensity as the control. This demonstrates that the amphoteric guars according to the present invention can enhance perfume delivery of the detergent composition.

### Example 2

Procedures as described in Example 1 was followed, expect that the oil perfume was replaced with an encapsulated perfume. The fragrance strength evaluation was also conducted as described in Example 1 except that the fabrics were hand rubbed for 5 times by the panelists before the fragrance intensity was smelt.

The formulations and results are shown in Table 2 below:

TABLE 2

| | Control | S4 | S5 | S6 | CS3 | CS4 |
|---|---|---|---|---|---|---|
| Components | wt % | wt % | wt % | wt % | wt % | wt % |
| Detergent base, | 0.2 | 0.2 | 0.2 | 0.2 | 0.2 | 0.2 |
| Fragrance Free | | | | | | |
| Perfume 2 | 0.001 | 0.001 | 0.001 | 0.001 | 0.001 | 0.001 |
| Amphoteric PS1 | — | 0.001 | — | — | — | — |
| Amphoteric PS2 | — | — | 0.001 | — | — | — |
| Amphoteric PS3 | — | — | — | 0.001 | — | — |
| Amphoteric PS4 | — | — | — | — | 0.001 | — |
| Anionic PS | — | — | — | — | — | 0.001 |
| Water | To 100 | To 100 | To 100 | To 100 | To 100 | To 100 |
| Panalists' | — | 8:0 | 7:1 | 6:2 | 2:6 | 4:4 |
| evaluation (8 | | | | | | |
| panalists in total) | | | | | | |

Perfume 2 is encapsulated perfume.

Results showed that amphoteric guars according to the present invention led to markedly stronger fragrance on the treated fabrics.

### Example 3

Washing Procedure:
1. Perfumes and guar powder were added and dispersed in a detergent base, then 1 g of the mixture was added into a pot with 500 ml water for washing.

| Washing Parameters | |
|---|---|
| Instrument | Launderometer (SDL Atlas |
| | Rotawash M228) |
| Water dosage per pot | 500 g |
| Detergent | Earthwise fragrance free liquid |
| | detergent |
| Detergent dosage | 1 g |
| Total number of fabric | 1 (15 cm by 15 cm) |
| piece per pot | |
| Fabric type | PECO |

2. After washing, removed and squeezed water from the fabrics.
3. For rinsing, placed textile swatches back into a clean pot with 500 mL water. Placed the pot back into the launderometer and rotated for 3 minutes for rinsing.
4. After rinsing, removed and squeezed water from the fabrics.
5. Dried the fabrics at room temperature overnight on aluminum foil.

Fragrance Strength Evaluation:

Fragrance strength assessment was carried out in a clean, odor-free environment, free from distractions. The fragrance intensity was evaluated by a group of panelists (8). The fabrics were hand rubbed by panelists for 5 times before the panelists smelt the fragrance. The fragrance strength was scored by the panelists in a score of from 1 to 10, wherein 1 represents the lightest fragrance strength and 10 represents the strongest.

The formulations and results are shown in Table 3 below:

TABLE 3

| Components | S7 (wt %) | CS5 (wt %) |
|---|---|---|
| Detergent base, Fragrance Free | To 100 | To 100 |
| Perfume 2 | 0.5 | 0.8 |
| Amphoteric PS2 | 0.5 | — |
| Fragrance Strength Score | 6.9 | 6.5 |

Results showed that in presence of the amphoteric polysaccharide according to the present invention, the composition incorporating only 0.5 wt % of the perfume could already achieve stronger fragrance strength than the composition which incorporates 0.8 wt % of perfume and does not contain any amphoteric polysaccharide. The results demonstrate a composition which requires low level of perfume for achieving satisfactory fragrance delivery.

1-17. (canceled)

18. A method for enhancing perfume delivery of a detergent composition having perfume, the method comprising the step of adding to said composition an amphoteric polysaccharide, wherein the amphoteric polysaccharide has a DS_{anionic} value greater than its DS_{cationic} value.

19. The method according to claim 18, wherein the amphoteric polysaccharide is an amphoteric galactomannan.

20. The method according to claim 18, wherein the amphoteric polysaccharide is an amphoteric guar.

21. The method according to claim 18, wherein the amphoteric polysaccharide is selected from the group consisting of carboxymethyl hydroxypropyltrimethylammonium chloride guars, carboxymethyl hydroxypropyl hydroxypropyltrimethylammonium chloride guars, and combinations thereof.

22. The method according to claim 18, wherein the amphoteric polysaccharide has a DS_{cationic} of from 0.001 to 0.1.

23. The method according to claim 18, wherein the amphoteric polysaccharide has an average molecular weight of between 1,000,000 Daltons and 2,500,000 Daltons.

24. The method according to claim 18, wherein the amphoteric polysaccharide has a DS_{anionic} of from 0.01 to 0.2.

25. The method according to claim 18, wherein the amphoteric polysaccharide is dispersed or dissolved in the detergent composition.

26. The method according to claim 18, wherein the detergent composition contains an anionic surfactant.

27. The method according to claim 18, wherein the detergent composition is a laundry detergent composition.

28. A detergent composition comprising at least:
a detergent,
a perfume, and
an amphoteric polysaccharide,
wherein the amphoteric polysaccharide has a DS_{anionic} value greater than its DS_{cationic} value, and the amphoteric polysaccharide has a DS_{cationic} value of 0.001 to 0.1.

29. A liquid detergent composition comprising:
from 1 to 20 wt % of a detergent,
from 0.001 to 0.5 wt % of a perfume,
from 0.1 to 1 wt % of an amphoteric polysaccharide, and
a liquid carrier,
wherein the amphoteric polysaccharide has a DS_{anionic} value greater than its DS_{cationic} value, and the amphoteric polysaccharide has a DS_{cationic} value of 0.001 to 0.1, the weight percentages are based on the total weight of the detergent composition.

30. The detergent composition according to claim 28, wherein the amphoteric polysaccharide has a DS_{anionic} value of from 0.01 to 0.2.

31. The detergent composition according to claim 28, wherein the amphoteric polysaccharide has an average molecular weight of between 1,000,000 Daltons and 2,500,000 Daltons.

32. The detergent composition according to claim 28, wherein the detergent is an anionic surfactant.

33. The detergent composition according to claim 28, wherein the detergent composition is a laundry detergent composition.

34. The liquid detergent composition according to claim 29, wherein the amphoteric polysaccharide has a DS_{anionic} value of from 0.01 to 0.2.

35. The liquid detergent composition according to claim 29, wherein the amphoteric polysaccharide has an average molecular weight of between 1,000,000 Daltons and 2,500,000 Daltons.

36. The liquid detergent composition according to claim 29, wherein the detergent is an anionic surfactant.

37. The liquid detergent composition according to claim 29, wherein the detergent composition is a laundry detergent composition.
